(19) United States
(12) Patent Application Publication
(10) Pub. No.: US 2018/0110349 A1
(43) Pub. Date: Apr. 26, 2018

(54) DRINK CONTAINER

(71) Applicant: Chin-Hsiung KUAN, New Taipei City (TW)

(72) Inventor: Chin-Hsiung KUAN, New Taipei City (TW)

(21) Appl. No.: 15/399,400

(22) Filed: Jan. 5, 2017

(30) Foreign Application Priority Data
Oct. 26, 2016 (TW) 105216270

(51) Int. Cl. A47G 19/22; F21V 23/04; F21V 33/00

(52) U.S. Cl. CPC A47G 19/2227; F21V 23/0442; F21Y 2115/10; A47G 2019/2238; A47G 2200/08; F21V 33/0036

(57) ABSTRACT

Disclosed is a drink container which comprises a container body and a light emitting unit, and the container body has an outer wall portion and an inner wall portion defining a drink receiving space for containing a drink, and both the inner wall portion and the outer wall portion have a transparent portion located in a position corresponding to the drink receiving space such that a light transmits from the drink receiving space through the transparent portions of the inner wall portion and the outer wall portion toward an outside of the container body, and the light emitting unit disposed and emitting light in the drink receiving space, wherein the light from the light emitting unit is visible from the outside of the container body by transmitting through the transparent portions of the inner wall portion and the outer wall portion.

### FIELD OF THE INVENTION

The present invention relates to a container, and more particularly to a drink container.

### BACKGROUND OF THE INVENTION

With the improvement of people's living standard, drinks have been popular that we usually see people holding a cup of coffee or tea in shops or streets.

There are a variety types of drinks available. People quench thirst, enjoy taste of drink, or refresh themselves by taking a drink. Beside the taste inside, a drink product has been with an attracting design to draw more attention from customers. Some common attracting designs we can find are enriching the color on a cover of drinks container, or further varying with different colors in the drinks by adding chemical composition in the drinks to obtain gradient color effect so as to enhance the sales of drinks.

However, adding chemical composition such as synthetic food colorings in the drinks may cause deleterious effects on people. Thus, the present invention provides an attracting design of a drink container.

### SUMMARY OF THE INVENTION

Thus, an object of the present invention is to provide a drink container which can improve color richness without affecting drinker's health.

The technical means adopted by the present invention to overcome the drawbacks in the prior art is to provide a drink container, comprising a container body having an outer wall portion and an inner wall portion defining a drink receiving space for containing a drink, both the inner wall portion and the outer wall portion having a transparent portion located in a position corresponding to the drink receiving space such that a light transmits from the drink receiving space through the transparent portions of the inner wall portion and the outer wall portion toward an outside of the container body, and a light emitting unit disposed and emitting light in the drink receiving space, wherein the light from the light emitting unit is visible from the outside of the container body by transmitting through the transparent portions of the inner wall portion and the outer wall portion.

In one embodiment of the present invention, the light emitting unit is a LED ice cube.

In one embodiment of the present invention, the light emitting unit includes a switch that controls the light emitting degree of the light emitting unit.

In one embodiment of the present invention, the switch is a sense switch or a press switch.

In one embodiment of the present invention, the sense switch is a liquid sensing switch.

In one embodiment of the present invention, the drink container further includes a cover body that seals the drink receiving space.

In one embodiment of the present invention, the container body is a cup body, a bag body, a can body or a bottle body.

In one embodiment of the present invention, the outer wall portion and the inner wall portion are commonly surrounded to form a peripheral wall and a bottom wall, and the transparent portions are formed at the peripheral wall.

In one embodiment of the present invention, the transparent portions are formed at a whole area of the peripheral wall.

In one embodiment of the present invention, the transparent portions are formed at a whole area of the peripheral wall and the bottom wall.

By means of the technology of the present invention, when the drink container is with liquid inside, a light from the light emitting unit can vary the appearance color of the drink container so as to enhance people's desire to drink without the necessity to add any chemical ingredients in the drink such that it avoids negative effects on drinker's health.

Preferably, the light emitting unit is a LED ice cube that uses a liquid sensing switch to emit light when a drink is in contact with the LED ice cube, which is a convenient and interesting way to have a drink.

### BRIEF DESCRIPTION OF THE DRAWINGS

FIG. 1 is a perspective view illustrating a drink container according to the first embodiment of the present invention;

FIG. 2 is a perspective view illustrating a drink container according to the second embodiment of the present invention.

### DETAILED DESCRIPTION OF THE PREFERRED EMBODIMENTS

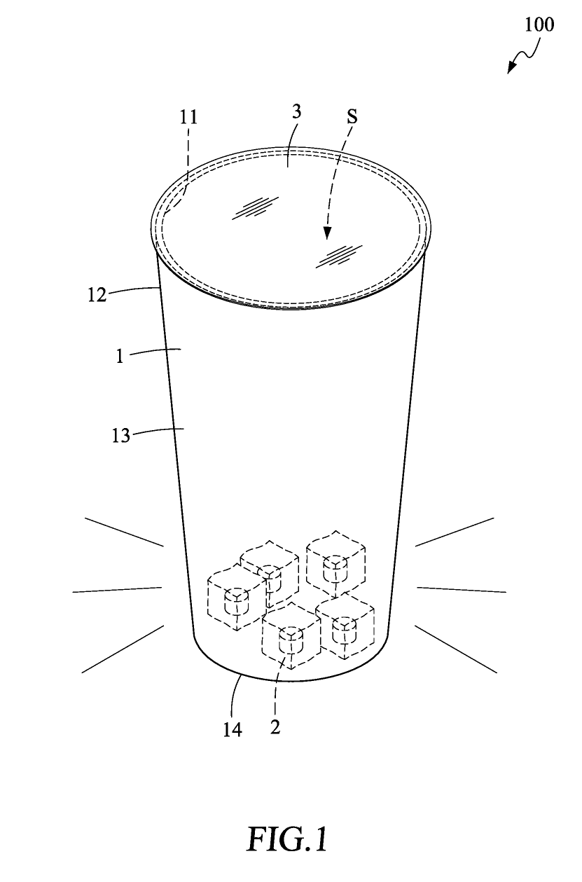

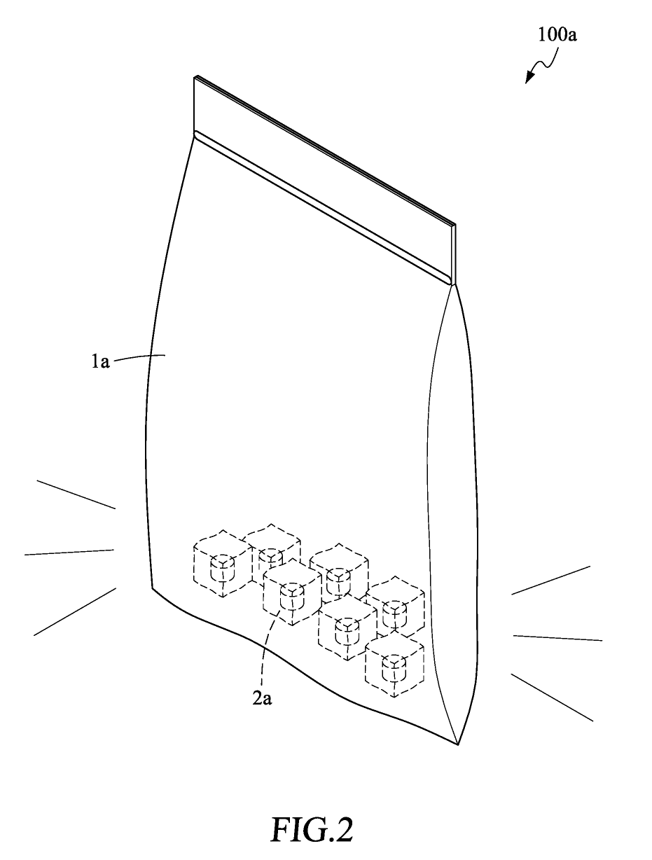

The preferred embodiments of the present invention are described below with reference to FIGS. 1 and 2. The description is only the explanation of the preferred embodiments, and is not the limitation of the implementation of the present invention.

As shown in FIG. 1, according to the first embodiment of the present invention, a drink container 100 comprises a container body 1 and a light emitting unit 2.

In the present embodiment, the container body 1 is a cup body. However, the present invention is not limited to this. The container body can be a bag body, a can body or a bottle body. For example, in another embodiment with reference to FIG. 2, a container body 1a of a drink container 100a is a bag body, and a light emitting unit 2a is disposed in the bag body.

Please refer back to FIG. 1. Specifically, the container body 1 has an inner wall portion 11 defining a drink receiving space S for containing a drink and an outer wall portion 12. The inner wall portion 11 and the outer wall portion 12 are commonly surrounded to form a peripheral wall 13 and a bottom wall 14, and both the inner wall portion 11 and the outer wall portion 12 have a transparent portion located in a position corresponding to the drink receiving space S such that a light transmits from the drink receiving space S through the transparent portions of the inner wall portion 11 and the outer wall portion 12 toward an outside of the inner wall portion 11 and the outer wall portion 12. Specifically, the material of the container body 1 can be fully transparent or semi-transparent, e.g. plastics. Preferably, the transparent portions can be formed at a whole area of the peripheral wall 13 and the bottom wall 14 for increasing the transparent area.

Specifically, the light emitting unit 2 which is a LED ice cube is disposed and provided to emit light in the drink receiving space S, and the light from the light emitting unit 2 is visible from the outside of the container body 1. The light emitting unit 2 includes a switch that controls the light emitting degree of the light emitting unit 2. In the present embodiment, the switch is a sense switch, e.g. a liquid sensing switch which can be triggered as the drink flows into the drink receiving space S. However, the present invention is not limited to this. The switch can be other switch types, e.g. a press switch. Besides, the switch can be a combination of various switch types, e.g. a combination of a liquid sensing switch and a press switch to control light emitting of the light emitting unit in a variety of conditions.

Preferably, as shown in FIG. 1, in the present embodiment, the drink container 100 further includes a cover body 3 for sealing the drink receiving space S. Specifically, the cover body 3 is sealing film.

The above description is only the explanation of the preferred embodiments of the present invention. However, a person with ordinary skill in the art may make various modifications to the present invention. Those modifications shall still fall within the spirit and the scope defined by the appended claims.

What is claimed is:

1. A drink container, comprising:
a container body having an outer wall portion and an inner wall portion defining a drink receiving space for containing a drink, both the inner wall portion and the outer wall portion having a transparent portion located in a position corresponding to the drink receiving space such that a light transmits from the drink receiving space through the transparent portions of the inner wall portion and the outer wall portion toward an outside of the container body, and
a light emitting unit disposed and emitting light in the drink receiving space,
wherein the light from the light emitting unit is visible from the outside of the container body by transmitting through the transparent portions of the inner wall portion and the outer wall portion.

2. The drink container of claim 1, wherein the light emitting unit is a LED ice cube.

3. The drink container of claim 1, wherein the light emitting unit includes a switch that controls the light emitting degree of the light emitting unit.

4. The drink container of claim 3, wherein the switch is a sense switch or a press switch.

5. The drink container of claim 4, wherein the sense switch is a liquid sensing switch.

6. The drink container of claim 1, further including a cover body that seals the drink receiving space.

7. The drink container of claim 1, wherein the container body is a cup body, a bag body, a can body or a bottle body.

8. The drink container of claim 1, wherein the outer wall portion and the inner wall portion are commonly surrounded to form a peripheral wall and a bottom wall, and the transparent portions are formed at the peripheral wall.

9. The drink container of claim 8, wherein the transparent portions are formed at a whole area of the peripheral wall.

10. The drink container of claim 8, wherein the transparent portions are formed at a whole area of the peripheral wall and the bottom wall.
